(19) United States
(12) Patent Application Publication
(10) Pub. No.: US 2022/0350003 A1
(43) Pub. Date: Nov. 3, 2022

(54) ELECTRONIC DEVICE AND BACKGROUND NOISE CALIBRATION METHOD

(71) Applicant: VIVO MOBILE COMMUNICATION CO., LTD., Dongguan (CN)

(72) Inventor: Xiaosheng ZHENG, Dongguan (CN)

(73) Assignee: VIVO MOBILE COMMUNICATION CO., LTD., Dongguan (CN)

(21) Appl. No.: 17/866,817

(22) Filed: Jul. 18, 2022

Related U.S. Application Data
(63) Continuation of application No. PCT/CN2021/071724, filed on Jan. 14, 2021.

(30) Foreign Application Priority Data
Jan. 21, 2020 (CN) 202010071361.0

(51) Int. Cl. G01S 7/497; G01S 17/50

(52) U.S. Cl. CPC G01S 7/497; G01S 17/50

(57) ABSTRACT

An electronic device and a background noise calibration method are provided. The electronic device includes a display screen; a transmitter, disposed on a non-display side of the display screen, and configured to transmit a first optical signal and a second optical signal to the display screen, where transmittance of the first optical signal passing through the display screen is greater than that of the second optical signal passing through the display screen; a receiver, disposed on the non-display side of the display screen, and configured to receive the first optical signal and the second optical signal; and a processor, connected to the receiver, and configured to determine a calibration coefficient according to the second optical signal received by the receiver and a second reference background noise, and determine a calibrated first reference background noise according to the calibration coefficient and a first reference background noise.

### CROSS-REFERENCE TO RELATED APPLICATIONS

This application is a continuation of International Application No. PCT/CN2021/071724, filed on Jan. 14, 2021, which claims priority to Chinese Patent Application No. 202010071361.0, filed on Jan. 21, 2020. The entire contents of each of the above-identified applications are expressly incorporated herein by reference.

### TECHNICAL FIELD

The present disclosure relates to the field of electronic devices, and in particular to an electronic device and a background noise calibration method.

### BACKGROUND

For an infrared sensor under a display screen, an infrared emitting lamp and an infrared receiving chip are placed under the display screen, and infrared light is emitted into the air through the display screen. When a person is approaching, the person's face reflects the infrared light, and the reflected light is sensed by the receiving chip through the display screen, and the receiving chip collects a reflection signal to determine whether the person is approaching.

An infrared signal transmitted in the air for face reflection is considered as a useful signal, and a signal that is strung into the receiving chip inside a structure is called a background noise. For example, a signal collected by the receiving chip after plurality of reflections of the infrared light through the display screen, a signal of optical crosstalk from a gap between a middle frame and the display screen, and a signal of optical crosstalk under the middle frame, and the like. When no object is approaching, the infrared light received by the chip includes only the background noise. A useful signal needs to pass through the display screen twice after being transmitted, and then can reach the receiving chip. Transmittance of the infrared light through the display screen is less than 10% only, resulting in a very weak useful signal and a stronger background noise than the useful signal, which is not conducive to identification of the useful signal. A slight difference in structure will lead to a great difference in an original background noise. Infrared background noises of machines produced in a same batch has bad consistency, which can be compensated through calibration. However, when deformation occurs in the structure, such as a gap change caused due to thermal expansion and cold contraction of glue, a background noise caused by structural deformation cannot be controlled, and changes in the background noise and a useful signal cannot be distinguished by the receiving chip, resulting in inaccurate and incorrect determination for the background noise. As a result, it cannot be accurately determined whether someone approaches the display screen.

### SUMMARY

In view of this, the present disclosure provides an electronic device and a background noise calibration method.

According to a first aspect, an electronic device according to an embodiment of the present disclosure includes a display screen, and further includes:

a transmitter, disposed on a non-display side of the display screen, and configured to transmit a first optical signal and a second optical signal to the display screen, where transmittance of the first optical signal passing through the display screen is greater than that of the second optical signal passing through the display screen;

a receiver, disposed on the non-display side of the display screen, and configured to receive the first optical signal and the second optical signal; and

a processor, connected to the receiver, and configured to determine a calibration coefficient according to the second optical signal received by the receiver and a second reference background noise, and determine a calibrated first reference background noise according to the calibration coefficient and a first reference background noise, where the first reference background noise is a theoretical value of the first optical signal received by the receiver when no object approaches the display screen, and the second reference background noise is a theoretical value of the second optical signal received by the receiver when no object approaches the display screen.

The processor is further configured to use a ratio of the second optical signal received by the receiver to the second reference background noise as the calibration coefficient.

The processor is further configured to use a product of the calibration coefficient and the first reference background noise as the calibrated first reference background noise.

The processor is further configured to calculate, according to the first optical signal received by the receiver and the calibrated first reference background noise, a variation of the first optical signal received by the receiver, and determine, according to the variation, whether an object approaches the display screen.

The electronic device further includes:

a middle frame, where the display screen is disposed on the middle frame; and

a printed circuit motherboard, disposed on the non-display side of the display screen, where the transmitter and the receiver are respectively disposed between the display screen and the printed circuit motherboard, and a light-shielding material piece is disposed on outer peripheries of the transmitter and the receiver.

According to a second aspect, a background noise calibration method according to an embodiment of the present disclosure can be applied to the electronic device in the foregoing embodiment and includes:

controlling a transmitter to transmit a first optical signal and a second optical signal from a non-display side of a display screen;

controlling a receiver to receive the first optical signal and the second optical signal from the non-display side of the display screen;

determining a calibration coefficient according to the received second optical signal and a second reference background noise; and

determining a calibrated first reference background noise according to the calibration coefficient and a first reference background noise,

where transmittance of the first optical signal passing through the display screen is greater than that of the second optical signal passing through the display screen; and

the first reference background noise is a theoretical value of the first optical signal received by the receiver when no object approaches the display screen, and the second reference background noise is a theoretical value of the second optical signal received by the receiver when no object approaches the display screen.

The determining a calibration coefficient according to the received second optical signal and a second reference background noise includes:

using a ratio of the second optical signal received by the receiver to the second reference background noise as the calibration coefficient.

The determining a calibrated first reference background noise according to the calibration coefficient and a first reference background noise includes:

using a product of the calibration coefficient and the first reference background noise as the calibrated first reference background noise.

The method further includes:

calculating a variation of the received first optical signal according to the received first optical signal and the calibrated first reference background noise, and determining, according to the variation, whether an object approaches the display screen.

According to a third aspect, an electronic device according to an embodiment of the present disclosure includes a processor, a memory, and a computer program that is stored in the memory and that can be run on the processor, where when the computer program is executed by the processor, the steps of the method in the foregoing embodiments are implemented.

According to a fourth aspect, a computer software product according to an embodiment of the present disclosure is stored in a non-volatile storage medium, where the computer software product is configured to be executed by at least one processor to implement the steps of the method in the foregoing embodiment.

According to a fifth aspect, an electronic device according to an embodiment of the present disclosure is configured to perform the method in the foregoing embodiment.

The technical solutions used in the present disclosure can achieve the following beneficial effects:

for the electronic device according to the embodiment of the present disclosure, the transmitter is disposed on the non-display side of the display screen, and is configured to transmit the first optical signal and the second optical signal to the display screen, and the transmittance of the first optical signal passing through the display screen is greater than that of the second optical signal passing through the display screen; the receiver is disposed on the non-display side of the display screen, and is configured to receive the first optical signal and the second optical signal; and the processor is configured to determine the calibration coefficient according to the second optical signal received by the receiver and the second reference background noise, and determine the calibrated first reference background noise according to the calibration coefficient and the first reference background noise. For the electronic device in the present disclosure, the calibration coefficient can be determined according to the second optical signal and the second reference background noise, and the calibrated first reference background noise can be determined according to the calibration coefficient and the first reference background noise, and then a change in the first reference background noise caused by structural deformation can be calibrated. Therefore, the influence of the structural deformation on the first reference background noise can be reduced, and the calibrated first reference background noise has high accuracy, which helps to determine whether an object approaches the display screen.

### BRIEF DESCRIPTION OF DRAWINGS

FIG. 1 is a schematic structural diagram of an electronic device according to an embodiment of the present disclosure; and

FIG. 2 is a schematic flowchart of a background noise calibration method according to an embodiment of the present disclosure.

### REFERENCE SIGNS

Display screen 10; Transmitter 20; Receiver 30;

Middle frame 40; Light-shielding material piece 50; Printed circuit motherboard 60; Object 70.

### DETAILED DESCRIPTION

The following describes the technical solutions of the embodiments of the present disclosure with reference to accompanying drawings of the present disclosure. Apparently, the described embodiments are a part rather than all of the embodiments of the present disclosure. All other embodiments obtained by a person of ordinary skill in the art based on the described embodiments of the present disclosure shall fall within the protection scope of the present disclosure.

An electronic device according to an embodiment of the present disclosure will be described in detail below.

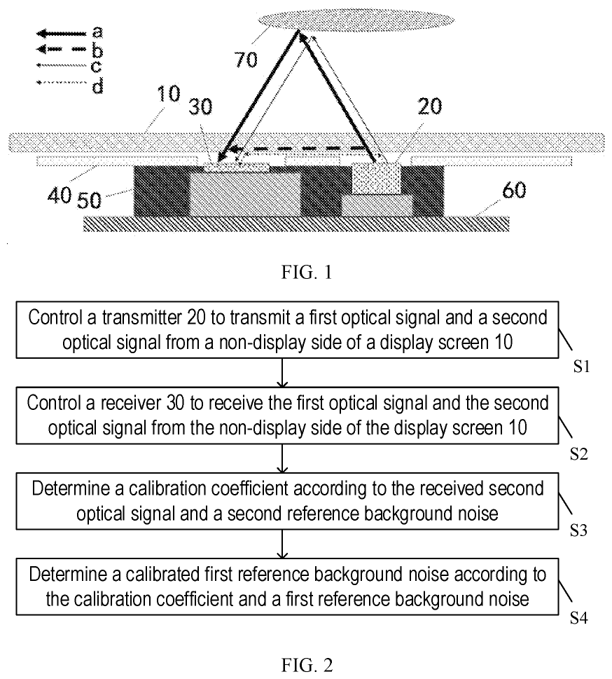

As shown in FIG. 1, an electronic device according to an embodiment of the present disclosure includes a display screen 10, and further includes a transmitter 20, a receiver 30, and a processor.

For example, the transmitter 20 is disposed on a non-display side of the display screen 10, and the transmitter 20 is configured to transmit a first optical signal and a second optical signal to the display screen 10, and transmittance of the first optical signal passing through the display screen 10 is greater than that of the second optical signal passing through the display screen 10. The receiver 30 is disposed on the non-display side of the display screen 10, and the receiver 30 is configured to receive the first optical signal and the second optical signal. The processor is connected to the receiver 30, and the processor is configured to determine a calibration coefficient according to the second optical signal received by the receiver 30 and a second reference background noise, and determine a calibrated first reference background noise according to the calibration coefficient and a first reference background noise. The first reference background noise is a theoretical value of the first optical signal received by the receiver 30 when no object approaches the display screen 10, and the second reference background noise is a theoretical value of the second optical signal received by the receiver 30 when no object approaches the display screen 10.

That is, the electronic device mainly includes the display screen 10, the transmitter 20, the receiver 30, and the processor. Both the transmitter 20 and the receiver 30 are disposed on the non-display side of the display screen 10. The transmitter 20 transmits the first optical signal and the second optical signal to the display screen 10. The transmitter 20 may be a Light Emitting Diode (LED) light source. The receiver 30 receives the first optical signal and the second optical signal. The first optical signal may be infrared light, such as infrared light with a wavelength of 950 nm. The transmittance of the first optical signal passing through the display screen 10 is greater than that of the second optical signal passing through the display screen 10, and the transmittance of the second optical signal passing through the display screen 10 may be much less than that of the first optical signal passing through the display screen 10. Therefore, relatively few second optical signals pass through the display screen 10, and more first optical signals pass through the display screen 10. When an object approaches the display screen 10, relatively many first optical signals are reflected by the object, which helps the receiver 30 to receive the signals and accurate calculation. A wavelength of light with low transmittance passing through the display 10 needs to be selected for the second optical signal, and the wavelength can be adjusted for transmittance for different display screens. According to transmittance for most current display screens, ultraviolet light with a wavelength less than 400 nm can be used for the second optical signal. Transmittance of the ultraviolet light with the wavelength less than 400 nm passing through the existing display screen is not more than 1% generally, which is low.

As shown in FIG. 1, light paths a and b are paths of the first optical signal, and optical paths c and d are paths of the second optical signal. When no object approaches the display screen 10, only light paths b and d exist. When an object 70 (such as a person's face) is approaching, light paths a and c exist after a reflection by the object 70. During application, light path c is not expected, and existence of light path c may cause the received second optical signal to be changed when the object is approaching, and then it is determined by mistake that a structural change occurs. Because light path c needs to pass through the display screen 10 twice, transmittance of the second optical signal passing through the display screen 10 is very low. For example, the transmittance is 1%, when energy of the second optical signal transmitted by the transmitter 20 and passing through the display screen is P, energy received by the receiver 30 is only 1/10,000 of P. Therefore, the energy is extremely low and can be ignored.

When no object approaches the display screen 10, the receiver 30 will not receive an optical signal reflected by the object. When no structural deformation occurs, the first reference background noise is a theoretical value of the first optical signal received by the receiver 30 when no object approaches the display screen 10, and the second reference background noise is a theoretical value of the second optical signal received by the receiver 30 when no object approaches the display screen 10. A second optical signal received by the receiver 30 when the structural deformation occurs is different from the second optical signal received when the no structural deformation occurs, and the first reference background noise and the second reference background noise are also changed when the structural deformation occurs. Because the transmittance of the second optical signal passing through the display screen is relatively low, a variation of the second reference background noise can be detected more accurately compared with a variation of the first reference background noise. To more accurately calculate a change in the first reference background noise caused by the structural deformation, it is necessary to calibrate the first reference background noise after obtaining a calibration coefficient according to the second optical signal received by the receiver 30.

The processor is connected to the receiver 30, and the processor can determine the calibration coefficient according to the second optical signal received by the receiver 30 and the second reference background noise. Because relatively few second optical signals pass through the display screen 10, when the structural deformation occurs, the calibration coefficient can be determined according to the second optical signal received by the receiver 30 and the second reference background noise. The first reference background noise is also changed correspondingly due to the structural deformation, and the calibrated first reference background noise can be determined according to the calibration coefficient and the first reference background noise. That is, when no object is approaching, only light paths b and d exist, and the first reference background noise and the second reference background noise can be obtained first. When the second reference background noise is changed, it is considered that structural deformation occurs, resulting in a change in the light paths. A change rate is calculated according to the change in the second reference background noise. Because paths of the first optical signal and the second optical signal are completely consistent, the change rate can be used as a calibration coefficient for calibrating the second reference background noise.

In an actual process, light path c does exist, light path c can be measured, and a maximum change value of light path c can be calculated. The maximum change value of light path c can be used as a minimum sensitivity range. During measurement, the maximum change value of c can be obtained while something is used to approach the display screen slowly, for example, the maximum change value of c is cmax. The structural deformation is considered to occur only when the change value of the second reference background noise is greater than the cmax. No structural deformation is considered to occur when the change value of the second reference background noise is less than the cmax. In addition, the display screen may be unglued during use by a user, which may affect other functions except infrared light, resulting in function abnormity. Micro-deformation of the structure can be detected through the change in the second reference background noise, so that parameter compensation can be performed or the user can be prompted. In addition, when the structural deformation (such as screen unglued) occurs, the user may not go through after-sales processing. Therefore, a defect rate of an unglued screen cannot be collected. Data of the structural deformation can further be collected based on the change in the second reference background noise, which helps to improve subsequent design, product quality, and user experience.

In the electronic device of the present disclosure, the calibration coefficient can be determined through the second optical signal and the second reference background noise, and the calibrated first reference background noise can be determined according to the calibration coefficient and the first reference background noise, and then the change in the first reference background noise caused by the structural deformation can be calibrated. Therefore, the influence of the structural deformation on the first reference background noise can be reduced, and the calibrated first reference background noise has high accuracy, which helps to accurately determine whether an object approaches the display screen.

In some embodiments of the present disclosure, the processor is further configured to use a ratio of the second optical signal received by the receiver 30 to the second reference background noise as the calibration coefficient. The processor is further configured to use a product of the calibration coefficient and the first reference background noise as the calibrated first reference background noise. For example, the first reference background noise is A when no object approaches the display screen 10, and the second reference background noise is B when no object approaches the display screen 10, and a second optical signal actually received by the receiver 30 is αB when the structural deformation occurs. In this case, a ratio of the second optical signal received by the receiver 30 to the second reference background noise is α, and α is used as the calibration coefficient. The first reference background noise is calibrated through α when the structural deformation occurs, and a product of the calibration coefficient α and a first reference background noise A is used as the calibrated first reference background noise αA. That is, the first reference background noise is αA when the structural deformation occurs, and a change in the first reference background noise caused by the structural deformation is calibrated, so that the influence of the structural deformation on the first reference background noise can be reduced.

In some other embodiments of the present disclosure, the processor is further configured to calculate, according to the first optical signal received by the receiver 30 and the calibrated first reference background noise, a variation of the first optical signal received by the receiver 30, and determine, according to the variation, whether an object approaches the display screen 10. The variation of the first optical signal received by the receiver 30 can be calculated more accurately through the calibrated first reference background noise, and it can be accurately determined whether an object approaches the display screen 10.

In some embodiments, the electronic device may further include a middle frame 40. The display screen 10 is disposed on the middle frame 40. An elastic layer, such as elastic glue, may be disposed between the middle frame 40 and the display screen 10, and hard contact between the display screen 10 and the middle frame 40 can be avoided through the elastic layer. The electronic device further includes a printed circuit motherboard 60. The printed circuit motherboard 60 is disposed on the non-display side of the display screen 10. The transmitter 20 and the receiver 30 are respectively disposed between the display screen 10 and the printed circuit motherboard 60, and the transmitter 20 and the receiver 30 can be disposed on the printed circuit motherboard 60. A light-shielding material piece 50 is disposed on outer peripheries of the transmitter 20 and the receiver 30. Under the condition that the transmitter 20 transmitting an optical signal and the receiver 30 receiving the optical signal are not affected, a light-shielding material can be filled in gaps between components to reduce mutual crosstalk of optical signals. The light-shielding material piece 50 may be disposed in gaps between the transmitter 20, the receiver 30, and the middle frame 40. For example, the light-shielding material piece 50 is provided in a gap between the transmitter 20 and the receiver 30, a gap between the transmitter 20 and the middle frame 40, and a gap between the receiver 30 and the middle frame 40, respectively. The light-shielding material piece 50 may be a silicone material cover, which can reduce the mutual crosstalk of optical signals, so that the receiver 30 can accurately calculate a received optical signal and reduce a deviation.

An embodiment of the present disclosure further provides a background noise calibration method.

As shown in FIG. 2, the background noise calibration method according to the embodiment of the present disclosure can be applied to the electronic device described in the foregoing embodiment and includes:

Step S1: Control a transmitter 20 to transmit a first optical signal and a second optical signal from a non-display side of a display screen 10;

Step S2: Control a receiver 30 to receive the first optical signal and the second optical signal from the non-display side of the display screen 10;

Step S3: Determine a calibration coefficient according to the received second optical signal and a second reference background noise; and

Step S4: Determine a calibrated first reference background noise according to the calibration coefficient and a first reference background noise.

Transmittance of the first optical signal passing through the display screen 10 is greater than that of the second optical signal passing through the display screen 10. The first reference background noise is a theoretical value of the first optical signal received by the receiver 30 when no object approaches the display screen 10, and the second reference background noise is a theoretical value of the second optical signal received by the receiver 30 when no object approaches the display screen 10. It should be noted that S1 to S4 in the foregoing steps do not represent a necessary sequence of steps, and a sequence of different steps can be adjusted according to actual needs.

That is, in the foregoing background noise calibration method, the first optical signal and the second optical signal are transmitted from the non-display side of the display screen 10, and the first optical signal and the second optical signal are received from the non-display side of the display screen 10. The first optical signal and the second optical signal can be transmitted through the transmitter 20, and the first optical signal and the second optical signal can be received through the receiver 30. The transmittance of the first optical signal passing through the display screen 10 is greater than that of the second optical signal passing through the display screen 10, and the transmittance of the second optical signal passing through the display screen 10 may be much less than that of the first optical signal passing through the display screen 10. Therefore, relatively few second optical signals pass through the display screen 10, and more first optical signals pass through the display screen 10. When an object approaches the display screen 10, relatively many first optical signals are reflected by the object, which help receiving by the receiver 30.

The calibration coefficient can be determined according to the second optical signal received by the receiver 30 and the second reference background noise. Because relatively few second optical signals pass through the display screen 10, when structural deformation occurs, the calibration coefficient can be determined according to the second optical signal received by the receiver 30 and the second reference background noise. The first reference background noise is a theoretical value of the first optical signal received by the receiver 30 when no object approaches the display screen 10, and the second reference background noise is a theoretical value of the second optical signal received by the receiver 30 when no object approaches the display screen 10. The first reference background noise of the first optical signal is also changed correspondingly due to the structural deformation, and the calibrated first reference background noise can be determined according to the calibration coefficient and the first reference background noise. In the foregoing method, a change in the first reference background noise caused by the structural deformation can be calibrated. Therefore, the influence of the structural deformation on the first reference background noise can be reduced, and the calibrated first reference background noise has high accuracy, which helps to determine whether an object approaches the display screen.

In this embodiment of the present disclosure, the determining a calibration coefficient according to the received second optical signal and a second reference background noise includes: using a ratio of the second optical signal received by the receiver 30 to the second reference background noise as the calibration coefficient.

According to this embodiment of the present disclosure, the determining a calibrated first reference background noise according to the calibration coefficient and a first reference background noise includes: using a product of the calibration coefficient and the first reference background noise as the calibrated first reference background noise.

In this embodiment of the present disclosure, the method may further include: calculating a variation of the received first optical signal according to the received first optical signal and the calibrated first reference background noise, and determining whether an object approaches the display screen 10 according to the variation. The variation of the first optical signal can be accurately determined according to the calibrated first reference background noise, which helps to accurately determine whether an object approaches the display screen.

An embodiment of the present disclosure further provides an electronic device, including a processor, a memory, and a computer program that is stored in the memory and that can be run on the processor. When the computer program is executed by the processor, processes of the foregoing method embodiments are implemented, and a same technical effect can be achieved. To avoid repetition, details are not described herein again.

Unless otherwise defined, the technical terms or scientific terms used in the present disclosure shall have the general meanings understood by a person having ordinary skill in the field in which the present disclosure falls. The “first”, “second” and similar words used in the present disclosure are only intended to distinguish different components, rather than to indicate any order, quantity, or importance. Similar words such as “connect” or “connection” are not limited to physical or mechanical connections, but may include electrical connections, no matter it is direct or indirect. “Upper,” “lower,” “left,” “right,” and the like are only intended to indicate a relative positional relationship. When an absolute position of the described object changes, the relative positional relationship changes accordingly as well.

A person of ordinary skill in the art may realize that units and algorithm steps of various examples described with reference to the embodiments disclosed in this specification can be implemented by using electronic hardware, or a combination of computer software and the electronic hardware. Whether these functions are performed by using hardware or software depends on a specific application and design constraints of the technical solutions. A person of ordinary skill in the art may use different methods to achieve the described functions for each particular application, but it should not be considered that the implementation goes beyond the scope of the present disclosure.

A person of ordinary skill in the art may clearly understand that, for convenient and simple description, for the specific working processes of the system, apparatus, and unit described above, reference may be made to a corresponding process in the foregoing method embodiments, and details are not described herein again.

In the embodiments provided in this application, it should be understood that the disclosed apparatus and method may be implemented in other manners. For example, the apparatus embodiment described above is only an example. For example, division into the units is only logical function division. There may be other division manners in actual implementation, for example, a plurality of units or components may be combined or integrated into another system, or some features may be ignored or not implemented. In addition, the displayed or discussed mutual couplings or direct couplings or communication connections may be implemented by using some interfaces. The indirect couplings or communication connections between apparatuses or units may be implemented in electronic, mechanical, or other forms.

The units described as separate parts may or may not be physically separate, and parts displayed as units may or may not be physical units, that is, may be located in one location, or may be distributed on a plurality of network units. Some or all of the units may be selected according to actual needs to achieve the objective of the solutions of the embodiments.

In addition, function units in the embodiments of the present disclosure may be integrated into one processing unit, or each of the units may exist alone physically, or two or more units are integrated into one unit.

If the functions are implemented in a form of software function units and sold or used as independent products, the functions may be stored in a computer-readable storage medium. Based on such understanding, the technical solutions of the present disclosure essentially, or the part contributing to the related art may be implemented in a form of a software product. The computer software product is stored in a storage medium, and includes several instructions for enabling a computer device (which may be a personal computer, a server, a network device, or the like) to perform all or some of the steps of the methods described in the embodiments of the present disclosure. The foregoing storage medium includes various media that can store a program code such as a USB flash disk, a mobile hard disk, a Read-Only Memory (ROM), a Random Access Memory (RAM), a magnetic disk, an optical disc, or the like.

A person of ordinary skill in the art can understand that all or some of the procedures in the methods of the foregoing embodiments may be implemented by a computer program controlling related hardware. The program may be stored in a computer-readable storage medium. When the program is executed, the procedures of the embodiments of the foregoing methods may be performed. The storage medium includes a magnetic disk, a compact disc, a ROM, a RAM, or the like.

It can be understood that the embodiments described in the present disclosure may be implemented by hardware, software, firmware, middleware, microcode, or a combination thereof. For implementation with hardware, modules, units, and subunits may be implemented in one or more Application Specific Integrated Circuits (ASIC), a Digital Signal Processor (DSP), a DSP Device (DSPD), a Programmable Logic Device (PLD), a Field-Programmable Gate Array (FPGA), a general-purpose processor, a controller, a microcontroller, a microprocessor, another electronic unit for implementing the functions of the present disclosure, or a combination thereof

For implementation with software, technologies described in the embodiments of the present disclosure may be implemented by executing functional modules (for example, a process and a function) in the embodiments of the present disclosure. A software code may be stored in the memory and executed by the processor. The memory may be implemented in the processor or outside the processor.

The foregoing embodiments are embodiments of the present disclosure. It should be noted that those of ordinary skill in the art can make various improvements and modifications without departing from the principles described in the present disclosure, which shall fall within the protective scope of the present disclosure.

1. An electronic device, comprising:
a display screen;
a transmitter, disposed on a non-display side of the display screen, and configured to transmit a first optical signal and a second optical signal to the display screen, wherein transmittance of the first optical signal passing through the display screen is greater than that of the second optical signal passing through the display screen;
a receiver, disposed on the non-display side of the display screen, and configured to receive the first optical signal and the second optical signal; and
a processor, connected to the receiver, and configured to determine a calibration coefficient according to the second optical signal received by the receiver and a second reference background noise, and determine a calibrated first reference background noise according to the calibration coefficient and a first reference background noise, wherein the first reference background noise is a theoretical value of the first optical signal received by the receiver when no object approaches the display screen, and the second reference background noise is a theoretical value of the second optical signal received by the receiver when no object approaches the display screen.

2. The electronic device according to claim 1, wherein the processor is further configured to use a ratio of the second optical signal received by the receiver to the second reference background noise as the calibration coefficient.

3. The electronic device according to claim 1, wherein the processor is further configured to use a product of the calibration coefficient and the first reference background noise as the calibrated first reference background noise.

4. The electronic device according to claim 1, wherein the processor is further configured to calculate, according to the first optical signal received by the receiver and the calibrated first reference background noise, a variation of the first optical signal received by the receiver, and determine, according to the variation, whether an object approaches the display screen.

5. The electronic device according to claim 1, further comprising:
a middle frame, wherein the display screen is disposed on the middle frame; and
a printed circuit motherboard, disposed on the non-display side of the display screen, wherein the transmitter and the receiver are respectively disposed between the display screen and the printed circuit motherboard, and a light-shielding material piece is disposed on outer peripheries of the transmitter and the receiver.

6. A background noise calibration method, performed by an electronic device, wherein the method comprises:
controlling a transmitter to transmit a first optical signal and a second optical signal from a non-display side of a display screen;
controlling a receiver to receive the first optical signal and the second optical signal from the non-display side of the display screen;
determining a calibration coefficient according to the received second optical signal and a second reference background noise; and
determining a calibrated first reference background noise according to the calibration coefficient and a first reference background noise,
wherein transmittance of the first optical signal passing through the display screen is greater than that of the second optical signal passing through the display screen; and
wherein the first reference background noise is a theoretical value of the first optical signal received by the receiver when no object approaches the display screen, and the second reference background noise is a theoretical value of the second optical signal received by the receiver when no object approaches the display screen.

7. The method according to claim 6, wherein the determining a calibration coefficient according to the received second optical signal and a second reference background noise comprises:
using a ratio of the second optical signal received by the receiver to the second reference background noise as the calibration coefficient.

8. The method according to claim 6, wherein the determining a calibrated first reference background noise according to the calibration coefficient and a first reference background noise comprises:
using a product of the calibration coefficient and the first reference background noise as the calibrated first reference background noise.

9. The method according to claim 6, further comprising:
calculating a variation of the received first optical signal according to the received first optical signal and the calibrated first reference background noise, and determining, according to the variation, whether an object approaches the display screen.

10. A non-transitory computer readable medium storing instructions that, when executed by a processor, cause the processor to perform a background noise calibration method, wherein the method comprises:
controlling a transmitter to transmit a first optical signal and a second optical signal from a non-display side of a display screen;
controlling a receiver to receive the first optical signal and the second optical signal from the non-display side of the display screen;
determining a calibration coefficient according to the received second optical signal and a second reference background noise; and
determining a calibrated first reference background noise according to the calibration coefficient and a first reference background noise,
wherein transmittance of the first optical signal passing through the display screen is greater than that of the second optical signal passing through the display screen; and
wherein the first reference background noise is a theoretical value of the first optical signal received by the receiver when no object approaches the display screen, and the second reference background noise is a theoretical value of the second optical signal received by the receiver when no object approaches the display screen.

11. The non-transitory computer readable medium according to claim 10, wherein the determining a calibration coefficient according to the received second optical signal and a second reference background noise comprises:
using a ratio of the second optical signal received by the receiver to the second reference background noise as the calibration coefficient.

12. The non-transitory computer readable medium according to claim 10, wherein the determining a calibrated first reference background noise according to the calibration coefficient and a first reference background noise comprises:
using a product of the calibration coefficient and the first reference background noise as the calibrated first reference background noise.

13. The non-transitory computer readable medium according to claim 10, wherein the method further comprises:
calculating a variation of the received first optical signal according to the received first optical signal and the calibrated first reference background noise, and determining, according to the variation, whether an object approaches the display screen.
